(19) United States
(12) Patent Application Publication
(10) Pub. No.: US 2010/0270985 A1
(43) Pub. Date: Oct. 28, 2010

(54) DC-DC CONVERTER

(75) Inventors: Ti-Hua Ko, Taipei (TW); Chia-Jen Kuo, Taipei (TW); Shan-Ying Shih, Taipei (TW)

Correspondence Address: WPAT, PC;INTELLECTUAL PROPERTY ATTORNEYS, 2030 MAIN STREET, SUITE 1300, IRVINE, CA, 92614, US

(73) Assignee: Well Shin Technology Co., Ltd., Taipei (TW)

(21) Appl. No.: 12/429,487

(22) Filed: Apr. 24, 2009

(51) Int. Cl. G05F 1/10

(52) U.S. Cl. 323/234

(57) ABSTRACT

A DC-DC converter includes a voltage input module receiving an input voltage from an exterior power supply, a voltage transforming module connected with the voltage input module for transforming the input voltage into a proper output voltage, a voltage output module connected with the voltage transforming module for supplying the proper output voltage to an exterior electric appliance, a first detecting module connected with the voltage output module for detecting an output current of the voltage output module and sending a corresponding current signal, a second detecting module connected with the voltage output module for detecting the output voltage of the voltage output module and sending a corresponding voltage signal, and a control module for receiving and analyzing the corresponding current and voltage signals and then generating a corresponding control signal so as to control the output voltage of the voltage transforming module for protecting the electric appliance.

### BACKGROUND OF THE INVENTION

1. Field of the Invention

The present invention generally relates to a converter, and more particularly to a DC-DC converter.

2. The Related Art

DC-DC converters are generally employed, for example, in chargers and adapters, to provide DC power for exterior electric appliances. However, some electric appliances, such as having low-frequency transformer of silicon steel sheet configured therein, must work by being provided AC power. So the DC-DC converter cannot be served for the some electric appliances. If the traditional DC-DC converter is misemployed for the electric appliance having the low-frequency transformer of silicon steel sheet or the like, the electric appliance are often easily damaged. Therefore, a DC-DC converter capable of protecting the unsuitable electric appliances, for which the DC-DC converter is misemployed, is required.

### SUMMARY OF THE INVENTION

An object of the present invention is to provide a DC-DC converter including a voltage input module receiving an input voltage from an exterior power supply, a voltage transforming module connected with the voltage input module for transforming the input voltage into a proper output voltage, a voltage output module connected with the voltage transforming module for supplying the proper output voltage to an exterior electric appliance, a first detecting module connected with the voltage output module for detecting an output current of the voltage output module and sending a corresponding current signal, a second detecting module connected with the voltage output module for detecting the output voltage of the voltage output module and sending a corresponding voltage signal, and a control module for receiving and analyzing the corresponding current and voltage signals sent by the first and second detecting modules and then generating a corresponding control signal so as to control the output voltage of the voltage transforming module for protecting the electric appliance.

As described above, the DC-DC converter of the present invention utilizes the first and second detecting modules to detect the output current and voltage of the voltage output module, and then utilizes the control module to receive and analyze the detected current and voltage signals so as to regulate the output voltage of the voltage output module. Therefore, even if the DC-DC converter is misemployed for an unsuitable electric appliance, it can still protect the electric appliance very well.

### BRIEF DESCRIPTION OF THE DRAWINGS

The present invention will be apparent to those skilled in the art by reading the following description, with reference to the attached drawings, in which:

FIG. 1 is a circuitry of a DC-DC converter according to the present invention;

FIG. 2 is a perspective view of a shield of the DC-DC converter; and

FIG. 3 is another angle of perspective view of the shield of FIG. 2.

### DETAILED DESCRIPTION OF THE PREFERRED EMBODIMENT

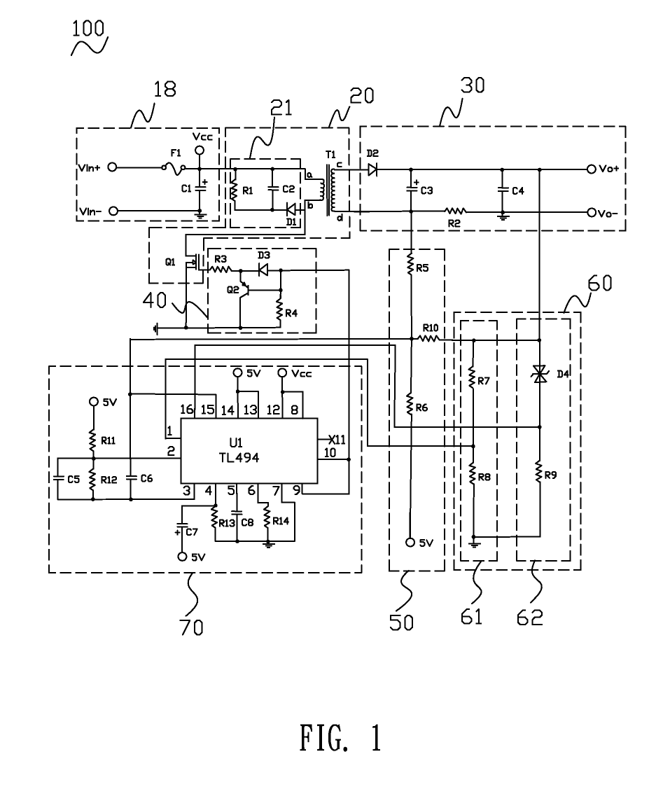

With reference to FIG. 1, a DC-DC converter 100 of the prevent invention includes a voltage input module 18, a voltage transforming module 20, a voltage output module 30, a driving module 40, a first detecting module 50, a second detecting module 60 and a control module 70.

The voltage input module 18 includes a positive input terminal Vin+, a negative input terminal Vin− connected to ground, and a first capacitor C1. The positive input terminal Vin+ and the negative input terminal Vin− are connected with an exterior power supply for getting an input voltage. The first capacitor C1 is connected between the positive input terminal Vin+ and the negative input terminal Vin− to filter and stabilize the input voltage.

The voltage transforming module 20 includes a snubber circuit 21, a switch element Q1 and a transformer T1. In the embodiment, the switch element Q1 is an N-channel FET. One terminal of the primary winding of the transformer T1 is connected to the positive input terminal Vin+ by means of a fuse F1 capable of protecting the DC-DC converter 100 against a high input current, and the other terminal thereof is connected with the drain of the switch element Q1. The source of the switch element Q1 is connected to ground, and the grid thereof is connected to the control module 70 through the driving module 40 so as to be controlled to be connected or disconnected so that can regulate an output voltage of the secondary winding of the transformer T1. The snubber circuit 21 is parallel connected with the primary winding of the transformer T1 and includes a second capacitor C2, a first diode D1 connected with the second capacitor C2 in series, and a first resistor R1 parallel connected with the second capacitor C2. The snubber circuit 21 can filter out additional voltage waves generated by connection/disconnection of the switch element Q1.

The voltage output module 30 includes a second diode D2, a second resistor R2, a third capacitor C3, a fourth capacitor C4, a positive output terminal Vo+ and a negative output terminal Vo−. One terminal of the secondary winding of the transformer T1 is connected to the positive output terminal Vo+ through the second diode D2, and the other terminal thereof is connected to the negative output terminal Vo− through the second resistor R2. One terminal of the third capacitor C3 is connected between the second resistor R2 and the secondary winding of the transformer T1, and the other terminal thereof is connected with the positive output terminal Vo+. Two terminals of the fourth capacitor C4 are respectively connected with the positive output terminal Vo+ and the negative output terminal Vo−. The negative output terminal Vo− is further connected to ground. The positive output terminal Vo+ and the negative output terminal Vo− are connected with an exterior electric appliance (not shown). After the input voltage is transformed by the voltage transforming module 20, the transformed voltage is further rectified by the second diode D2 and then is filtered by the third capacitor C3 and the fourth capacitor C4 so that a relatively steady output voltage can be supplied to the electric appliance.

The driving module 40 includes a triode Q2 having the emitter connected to the grid of the switch element Q1 through a third resistor R3 and the collector connected to ground. The base of the triode Q2 is, on one hand, connected to the collector by means of a fourth resistor R4, and on the other, connected to the emitter through a third diode D3. The base of the triode Q2 is further directly connected with the control module 70. So the driving module 40 can be controlled by the control module 70 to drive the switch state of the switch element Q1.

The first detecting module 50 has an over-current protection function and includes a first resistance element R5, a second resistance element R10 and a third resistance element R6. One terminal of the first resistance element R5 is connected to the negative output terminal Vo− through the second resistor R2, one terminal of the second resistance element R10 is connected with the positive output terminal Vo+, and other two terminals of the resistance elements R5, R10 are connected with each other and further connected with 5V voltage through the third resistance element R6 so that the resistance elements R5, R10 have a voltage-dividing function to the output voltage and can detect the output current of the voltage output module 30 according to the potential at the connection location of the resistance elements R5, R10, R6, and then send a corresponding current signal. The connection location of the resistance elements R5, R10, R6 is further drawn forth to be connected with the control module 70 so as to transmit the corresponding current signal (namely the potential at the connection location of the resistance elements R5, R10, R6) sent by the first detecting module 50 to the control module 70.

The second detecting module 60 includes two parallel branches designated as a feedback circuit 61 and a voltage-over protecting circuit 62. The feedback circuit 61 includes a fourth resistance element R7 and a fifth resistance element R8 series-connected with each other. Another terminal of the fourth resistance element R7 is connected with the positive output terminal Vo+, and another terminal of the fifth resistance element R8 is connected to ground. The voltage-over protecting circuit 62 includes a transient voltage suppressor D4 and a sixth resistance element R9 series-connected with each other. Another terminal of the transient voltage suppressor D4 is connected with the positive output terminal Vo+. Another terminal of the sixth resistance element R9 is connected to ground. The connection location of the fourth resistance element R7 and the fifth resistance element R8 is drawn forth to be connected with the control module 70, and the connection location of the transient voltage suppressor D4 and the sixth resistance element R9 is also drawn forth to be connected with the control module 70. The second detecting module 60 can detect the output voltage of the voltage output module 30 and send a corresponding voltage signal, and then transmit the corresponding voltage signal to the control module 70, wherein the transient voltage suppressor D4 is disconnected under the normal working state of the DC-DC converter 100.

The control module 70 has a control chip U1, in the embodiment, the control chip U1 is a TL494 type of chip which is widely used and known very well by technicians of this field so that is gone into details no longer here. The control chip U1 has 16 pins designated as Pin 1˜Pin 16. The Pin 2 is connected to 5V voltage through a fifth resistor R11, wherein a standard voltage value is supplied to the Pin 2 after the 5V voltage is voltage-divided by the fifth resistor R11. The Pin 2 is further connected to the Pin 3 by means of a sixth resistor R12 and a fifth capacitor C5 parallel-connected with each other. The Pin 3 is further connected to the Pin 15 through a sixth capacitor C6. The Pin 4, the Pin 5 and the Pin 6 are connected to ground by means of a seventh resistor R13, a eighth capacitor C8 and a eighth resistor R14 respectively. The Pin 4 is further connected to 5V voltage through a seventh capacitor C7. The Pin 7 is directly connected to ground. The Pins 8, 12 are connected with a reference voltage Vcc, and the Pins 13, 14 are directly connected with 5V voltage. The Pin 1 is connected to the connection location of the fourth resistance element R7 and the fifth resistance element R8 so as to receive an output voltage feedback signal detected by the feedback circuit 61. The Pin 15 is connected to the connection location of the first resistance element R5, the second resistance element R10 and the third resistance element R6 for receiving the corresponding current signals (namely the potential at the connection location of the resistance elements R5, R10, R6) sent by the first detecting module 50. The Pin 16 is connected to the connection location of the transient voltage suppressor D4 and the sixth resistance element R9 so as to receive the corresponding voltage signals sent by the voltage-over protecting circuit 62. The Pins 9, 10 are connected with the base of the triode Q2 of the driving module 40 so as to control the switch state of the switch element Q1 of the voltage transforming module 20 by means of the driving module 40.

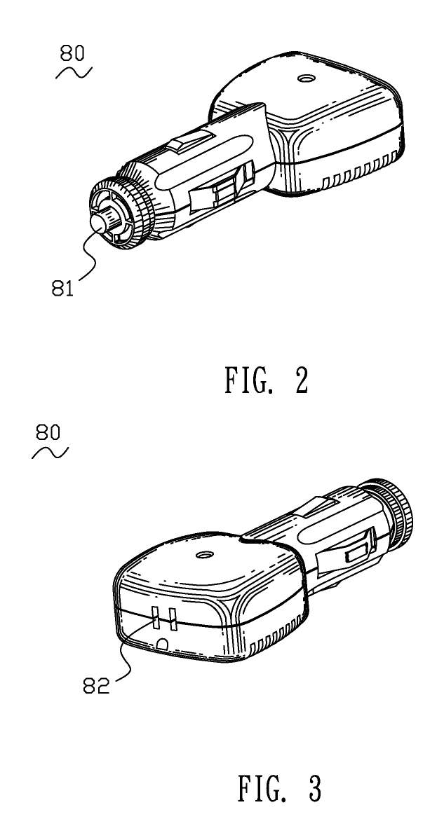

Referring to FIG. 2 and FIG. 3, the DC-DC converter 100 further includes a shield 80 having an input portion 81 and an output portion 82. The input portion 81 shows a structure of car cigar-lighter plug and is electrically connected with the voltage input module 18 so that the voltage input module 18 can be connected to the exterior power supply by means of the input portion 81. The output portion 82 may be a serial interface or a power socket etc. and is electrically connected with the voltage output module 30 so that the voltage output module 30 can be connected to the exterior electric appliance by means of the output portion 82. In the embodiment, the output portion 82 is a common power socket.

When the DC-DC converter 100 is in the normal working state, the transient voltage suppressor D4 is disconnected. The control chip U1 of the control module 70 receives the output voltage feedback signals detected by the feedback circuit 61 through the Pin 1 and then compares the output voltage feedback signals with the standard voltage value of the Pin 2 so as to generate corresponding control signals. Then the Pins 9, 10 of the control chip U1 transmit the control signals to control the switch frequency of the switch element Q1 by means of the driving module 40 so as to regulate an average input voltage of the primary winding of the transformer T1 so that a relatively steady output voltage can be supplied by the voltage output module 30 to the electric appliance.

When the output voltage of the DC-DC converter 100 is over-high to result in the breakdown of the transient voltage suppressor D4, the control chip U1 of the control module 70 receives output voltage over-high signals detected by the voltage-over protecting circuit 62 through the Pin 16 and then compares the detected voltage signals with a voltage value of the Pin 15, wherein the detected voltage is higher than the voltage value of the Pin 15. Then the Pins 9, 10 of the control chip U1 transmit a low-level control signal according to the compared result to make the switch element Q1 disconnected by means of the driving module 40 so that makes the output voltage of the DC-DC converter 100 to be zero so as to protect the electric appliance.

When the positive output terminal Vo+ and the negative output terminal Vo− of the voltage output module 30 are short circuited or misconnected with an unsuitable electric appliance, such as having low-frequency transformer of silicon steel sheet configured therein, the output current of the DC-DC converter 100 is over-high. As a result, the potential at the connection location of the first resistance element R5, the second resistance element R10 and the third resistance element R6 is gradually decreased to zero so that makes the voltage value of the Pin 15 of the control chip U1 gradually decreased to zero. Then the Pins 9, 10 of the control chip U1 transmit a low-level control signal to make the switch element Q1 disconnected by means of the driving module 40 so that makes the output voltage of the DC-DC converter 100 to be zero so as to protect the electric appliance and the DC-DC converter 100.

As described above, the DC-DC converter 100 utilizes the detecting modules 50, 60 to detect the output current and voltage of the voltage output module, and then utilizes the control module 70 to receive and analyze the detected current and voltage signals and further control the switch state of the switch element Q1 so as to regulate the output current and voltage of the voltage output module. Therefore, even if the DC-DC converter 100 is misemployed for the foregoing unsuitable electric appliance, it can still protect the electric appliance very well.

What is claimed is:

1. A DC-DC converter, comprising:
a voltage input module receiving an input voltage from an exterior power supply;
a voltage transforming module connected with the voltage input module for transforming the input voltage into a proper output voltage;
a voltage output module connected with the voltage transforming module for supplying the proper output voltage to an exterior electric appliance;
a first detecting module connected with the voltage output module for detecting an output current of the voltage output module and sending a corresponding current signal;
a second detecting module connected with the voltage output module for detecting the output voltage of the voltage output module and sending a corresponding voltage signal; and
a control module for receiving and analyzing the corresponding current and voltage signals sent by the first and second detecting modules and then generating a corresponding control signal so as to control the output voltage of the voltage transforming module for protecting the electric appliance.

2. The DC-DC converter as claimed in claim 1, wherein the first detecting module includes at least three resistance elements, two of which are connected to a positive output terminal and a negative output terminal of the voltage output module, respectively, and another is connected with a reference voltage, other three terminals of the three resistance elements are connected with one another so that the resistance elements can voltage-divide to the output voltage for generating a potential at the connection location of the resistance elements namely the detected current signal, the control module is connected with the connection location of the resistance elements.

3. The DC-DC converter as claimed in claim 1, wherein the control module analyzes the corresponding voltage signal sent by the second detecting module by means of comparing the voltage signal with a default voltage value in the control module.

4. The DC-DC converter as claimed in claim 1, wherein the second detecting module includes a voltage-over protecting circuit capable of preventing the output voltage from being over-high and having a transient voltage suppressor and a resistance element series-connected with each other, another terminal of the transient voltage suppressor is connected with a positive output terminal of the voltage output module, another terminal of the resistance element is connected to a negative output terminal of the voltage output module, the control module is connected with the connection location of the transient voltage suppressor and the resistance element.

5. The DC-DC converter as claimed in claim 1, wherein the voltage transforming module includes a switch element and a transformer, one terminal of a primary winding of the transformer is connected with the voltage input module and the other terminal thereof is connected with the switch element, the voltage output module is connected with a secondary winding of the transformer, the control module is connected with the switch element so as to control a switch state of the switch element according to the control signal and further regulate the output voltage of the transformer according to the switch state.

6. The DC-DC converter as claimed in claim 5, wherein the switch element is an N-channel FET having the drain connected with the primary winding of the transformer, the source connected to ground, and the grid connected to the control module.

7. The DC-DC converter as claimed in claim 5, wherein the voltage transforming module further includes a snubber circuit parallel-connected with the primary winding of the transformer for filtering out additional voltage waves generated by connection and disconnection of the switch element, the snubber circuit includes a capacitor, a first diode series-connected with the capacitor, and a first resistor parallel connected with the capacitor.

8. The DC-DC converter as claimed in claim 5, wherein the DC-DC converter further includes a driving module connected between the switch element and the control module for being controlled by the control module to drive the switch state of the switch element, the driving module includes a triode having the emitter connected to the switch element through a third resistor and the collector connected to ground, the base of the triode is, on one hand, connected to the collector by means of a fourth resistor, and on the other, connected to the emitter through a third diode, the base of the triode is further directly connected with the control module.

9. The DC-DC converter as claimed in claim 1, further comprising a shield having an input portion and an output portion, the input portion showing a structure of car cigar-lighter plug and being electrically connected with the voltage input module, the output portion being a serial interface or a power socket and electrically connected with the voltage output module.
